(19) United States
(12) Patent Application Publication
(10) Pub. No.: US 2026/0180055 A1
(43) Pub. Date: Jun. 25, 2026

(54) MOBILE ENERGY SUPPLY DEVICE WITH A SENSOR ELEMENT AND METHOD FOR MOUNTING A SENSOR ELEMENT ON AN ENERGY SUPPLY DEVICE

(71) Applicant: ANDREAS STIHL AG & Co. KG, Waiblingen (DE)

(72) Inventors: Tobias WUERSCHUM, Neubulach (DE); Victor PETERS, Tamm (DE); Friedhelm KOCH, Allmersbach im Tal (DE)

(73) Assignee: ANDREAS STIHL AG & Co. KG, Waiblingen (DE)

(21) Appl. No.: 19/426,270

(22) Filed: Dec. 19, 2025

(30) Foreign Application Priority Data
Dec. 23, 2024 (DE) 10 2024 139 599.0

(51) Int. Cl. H01M 10/48; G01K 7/16; H01M 50/213; H01M 50/291

(52) U.S. Cl. CPC H01M 10/482; G01K 7/16; H01M 10/486; H01M 50/213; H01M 50/291; H01M 2220/30

(57) ABSTRACT

The invention relates to a mobile energy supply device with a retaining frame for arranging at least one cell unit in a mounting direction (M), wherein the retaining frame comprises at least one mounting structure for a sensor element for detecting at least one operating state of the at least one cell unit, wherein the at least one mounting structure comprises a contact section which is configured, in an assembly state, to adjustably change a shape of the sensor element at least in sections and to arrange the at least sectionally shape-changed sensor element in a defined location relative to the at least one cell unit in order to be able to detect the at least one operating state at the at least one cell unit. The invention also relates to a method for mounting a sensor element on a mobile energy supply device.

### CROSS REFERENCE TO RELATED APPLICATIONS

This application, which claims priority under 35 U.S.C. §119 of German Application No. DE 10 2024 139 599.0, filed on December 23, 2024, the disclosures of which are incorporated by reference.

### BACKGROUND OF THE INVENTION

The present invention lies in the field of electrical power supply technology and relates to a mobile energy supply device with at least one sensor element. The present invention also relates to a method for mounting the at least one sensor element on a mobile energy supply device.

Mobile energy supply devices with at least one cell unit or with a plurality of cell units (also referred to as "cells" for short) must meet a variety of requirements and are configured depending on their area of application and intended use.

Mobile energy supply devices require, for example, a monitoring of the temperature during a charging process. The monitoring of the temperature is generally realized by a so-called battery management system in conjunction with at least one temperature sensor. The temperature sensor and the battery management system with respective electrical/electronic parts and components are generally fastened on a circuit board (PCB) of the energy supply device.

In mobile energy supply devices, so-called NTC sensors ("NTC" is an abbreviation for "negative temperature coefficient") are frequently used to measure the temperature. An NTC sensor is a semiconductor component whose electrical resistance changes with the temperature. A typical NTC sensor is characterized by a sensor head and two electrical conductors, which are generally each formed of a single wire and serve for connecting and fastening the sensor on the circuit board.

An NTC sensor is immersed in a pocket of the cell holder, which is filled with a thermally conductive paste. The pocket is arranged at the cell holder corresponding to a cell unit and further comprises openings. The thermally conductive paste can pass through the openings and contact the cell unit. Heat generated in the cell unit is transferred into the thermally conductive paste. The temperature in the thermally conductive paste can be determined via the NTC sensor.

In such a known arrangement, the position of the NTC sensor, i.e., the sensor head, is generally not precisely defined. Due to the configuration, a precise, and in particular sufficiently accurate, measurement of the temperature cannot be ensured. The sensor head can be arranged within the thermally conductive paste at different distances from the cell unit, for example. This can result, in particular, in an inaccuracy and/or a delay in the measurement of the temperature.

### SUMMARY OF THE INVENTION

It is an object of the present invention is to provide a mobile energy supply device with a sensor element that enables an improved, in particular more accurate, detection of at least one operating state of at least one cell unit by means of a sensor element. Furthermore, it is an object of the present invention to provide a method for mounting a sensor element on a mobile energy supply device.

The object is solved by the features of independent claims 1 and 10. Further embodiments and applications of the present invention are apparent from the dependent claims and are explained in more detail in the following description with partial reference to the figures.

The present invention relates, according to a first general aspect, to a mobile energy supply device with a retaining frame for arranging at least one cell unit essentially in an mounting direction, wherein the retaining frame comprises at least one mounting structure for a sensor element for detecting at least one operating state of the at least one cell unit, wherein the at least one mounting structure comprises a contact section which is configured, in an assembly state, to adjustably change a shape of the sensor element at least in sections, in particular at least in sections along a longitudinal direction of the sensor element, and to arrange the at least sectionally shape-changed sensor element in a defined location relative to the at least one cell unit in order to be able to detect the at least one operating state (directly, immediately) at the at least one cell unit.

The present invention provides a mobile energy supply device, which is characterized by a more precise arrangement of the sensor element, in particular a sensor head of the sensor element, relative to the at least one cell unit (also referred to as "cell" for short). This enables an improved (more accurate) detection of the at least one operating state of the at least one cell unit. For the sake of simplicity, the term "mobile" is omitted in connection with the energy supply device in the following.

By the present invention, for example, manufacturing tolerances of the sensor element and/or assembly tolerances can be substantially compensated. In other words, the present invention can ensure that manufacturing tolerances and/or assembly tolerances play a minor or subordinate role. By means of the contact section of the mounting structure of the retaining frame of the energy supply device, the shape of the sensor element in the assembly state can be adjustably changed at least in sections and/or is adjustably changed at least in sections, so that an arrangement of the sensor element relative to the at least one cell unit in a defined location is ensured.

The defined location can comprise a position and/or an orientation of the sensor element, in particular a sensor head of the sensor element, in which the sensor element contacts the at least one cell unit directly (immediately) or is arranged at a defined distance from the at least one cell unit. As a result, detecting the at least one operating state, for example a temperature, of the at least one cell unit can be performed more precisely.

Through the configuration of the contact section of the at least one mounting structure, the sensor element can be arranged in the defined location in the assembly state without further components. In particular, no additional elements or devices are required for arranging and/or orientating the sensor element during a mounting process of the sensor element.

The contact section can be arranged and/or formed on the mounting structure to deform the sensor element at least in sections during a mounting process, for example, to deform essentially reversibly or to deform irreversibly. The contact section can be formed, for example, as a ramp, a rib, a groove, and/or a channel. In the assembly state, the sensor element is, in terms of its shape adjustably changed at least in sections and thus shape-changed. In other words, the contact section is configured for sectional deformation of the sensor element in the assembly state. The contact section is a deformation section with respect to the sensor element. In addition or alternatively, the contact section can be configured as an orientation section for orientating the sensor element, in particular at least a section of the sensor element. The contact section can be formed essentially plate-shaped. In addition or alternatively, the contact section can be arranged and/or formed to be essentially inclined relative to the mounting direction.

The at least one operating state comprises, in particular, a temperature and/or a change in temperature. The sensor element can, for example, be formed and/or configured as a sensor element for detecting a temperature. The sensor element can comprise a sensor head with a sensor chip. The sensor element can comprise two sensor holders in the configuration of wires as connection and/or mounting wires. In a manufacturing state of the sensor element, the two wires can be arranged essentially parallel to each other and/or spaced apart from each other and/or connected to the sensor head. The sensor holders can be configured, among other things, to support a sensor head of the sensor element. The sensor holders can be coated with an insulating material in sections. The temperature can be measured in the defined location of the sensor element directly (immediately) at the at least one cell unit.

The sensor element can be configured in particular as a so-called NTC sensor ("NTC" is an abbreviation for "negative temperature coefficient") in order to detect a temperature by measuring a change in the resistance of the NTC sensor. The sensor element can be designed as an NTC sensor known from the prior art.

The energy supply device is, in particular, a hand-held, hand-guided, manually tool-free mountable/dismountable, exchangeable, and/or rechargeable energy supply device. In other words, the energy supply device can be configured as a so-called battery pack. The energy supply device can, for example, comprise a single cell unit or a plurality of cell units. The single cell unit or the plurality of cell units can be configured on the basis of lithium-ion storage technology. The energy supply device can be configured to supply electrical power to an electrical device, in particular a hand-held electric tool.

The assembly state is, in particular, a manufacturing state of the energy supply device in which the sensor element is arranged in the defined location relative to the at least one cell unit and is characterized by a shape that is changed at least in sections in the defined location.

It is possible that, in the assembly state, the sensor element is mechanically fastened and/or electrically contacted by means of a carrier material structure for at least one unit of the energy supply device, in particular for an electronic processing unit of the energy supply device for processing the detected at least one operating state of the at least one cell unit, or by means of a housing section of a housing of the energy supply device, wherein the carrier material structure or the housing section is in each case connected to the retaining frame by an mounting process in the mounting direction, wherein, in the assembly state, the sensor element, in particular at least one sensor head of the sensor element, is received in the mounting structure, wherein the mounting structure is arranged opposite the carrier material structure or the housing section in the mounting direction.

The carrier material structure can be formed as a circuit carrier. The carrier material structure can be designed as a circuit board (PCB). The carrier material structure can, in particular, be formed plate-shaped and/or flat.

The electronic processing unit can be configured in particular for evaluating the detected at least one operating state. The electronic processing unit for processing the detected at least one operating state can be a component of a battery management system of the energy supply device. The electronic processing unit can be arranged on the carrier material structure and connected to the sensor element.

The sensor element can be fastened to the carrier material structure or to the housing section. Sensor holders of the sensor element, for example in the configuration of wires, can be fastened to the carrier material structure as connection and/or mounting wires. The fastening can be realized, for example, by means of at least one of the following connections: an essentially form-fitting connection (e.g., a plug connection or a snap connection), an essentially force-fitting connection (e.g., a press connection), and/or an essentially material-fitting connection (e.g., a weld connection or a solder connection).

According to a further aspect of the present invention, it can be provided that the sensor element comprises two sensor holders which extend from a sensor head of the sensor element essentially in a longitudinal direction of the sensor element and are arranged opposite each other and/or spaced apart from each other, wherein, in particular, for maintaining (ensuring or preserving) a distance between the two sensor holders, a spacer element can be arranged between the two sensor holders, which is mounted so as to be displaceable essentially in the longitudinal direction of the sensor element and thus along the longitudinal direction of the sensor holders in order to set a defined variability of a shape of the sensor element.

Each of the sensor holders can be formed pencil-shaped, pin-shaped, cylindrical, wire-shaped, and/or needle-shaped. Each of the sensor holders can be formed at least in sections essentially dimensionally stable and/or at least in sections essentially dimensionally variable and/or at least in sections deformable. Each of the sensor holders can be formed in sections essentially reversibly deformable, for example spring-elastically, and/or essentially irreversibly (plastically). Each of the sensor holders is formed in particular from a metallic material.

During the mounting process, the sensor element of the energy supply device undergoes in sections a change in its shape and is thus, in the assembly state, characterized by a changed shape at least in sections. The changed shape is particularly present in the area of the sensor holders. In other words, the sensor element has a different shape in its initial state than in its assembly state.

The spacer element can, for example, be arranged as a clamping element between the two sensor holders and arrange the sensor holders at a defined distance from each other. In other words, the spacer element forms a support element between the sensor holders. The sensor element can comprise at least two sensor holders.

It is possible that the contact section is arranged opposite the at least one cell unit and/or spaced apart from the at least one cell unit and is configured to deform, in particular to deform reversibly, and/or to displace the sensor element at least in sections in the direction of the at least one cell unit as a result of an assembly movement along the mounting direction. The contact section is in particular configured to guide a sensor head of the sensor element toward the cell unit, that is, in the direction of the cell unit.

The contact section can, for example, be formed plate-shaped and/or essentially flat. The contact section can be configured, on the one hand, to guide the sensor element and, on the other hand, to deform the sensor element in sections, in particular if the sensor element is moved linearly (translationally) essentially along the mounting direction in the course of the mounting process.

The assembly movement of the mounting process is, in particular, a linear (translational) movement by means of which the sensor element is moved in the direction of the assembly section and thus in the direction of the contact section essentially in the mounting direction. For this purpose, the sensor element is, in particular, already fastened to the carrier material structure. By means of the assembly movement, the sensor element can be arranged in the defined location in conjunction with the contact section, wherein the sensor element is adjustably changed in shape at least in sections, at least upon reaching the assembly state.

The adjustable sectional change in shape of the sensor element can be formed in particular in the area of the sensor holder of the sensor element.

According to a further aspect of the present invention, it can be provided that the contact section comprises a contact surface which is associated with the sensor element and configured to support the sensor element, in particular a sensor head of the sensor element, in the assembly state in at least one direction, in particular in order to exert a pressure force on the sensor element for contacting the sensor element with the at least one cell unit.

The contact surface can be a deformation surface with respect to the sensor element, which is configured to adjustably deform the sensor element at least in sections as a result of a movement essentially in the mounting direction and thus to adjustably change the shape of the sensor element at least in sections.

It is possible that the contact section comprises a contact surface which is associated with (facing) the sensor element, wherein the contact surface, in particular depending on the configuration of the sensor element, for example a sensor head of the sensor element, is characterized by at least one of the following configurations: essentially planar (flat), essentially tapering along the mounting direction, wedge-shaped, trapezoidal, concavely curved, channel-shaped, trough-shaped; in order in each case to guide and/or position and/or orientate the sensor element, in particular a sensor head of the sensor element, in the defined location in the assembly state.

The contact surface is, in particular, the surface by means of which a sensor head of the sensor element makes contact and which arranges the sensor head in the defined location relative to the at least one cell unit.

An essentially planar (flat) contact surface can be arranged and/or oriented at an angle to the mounting direction.

According to a further aspect of the present invention, it can be provided that the mounting structure is characterized by one of the following configurations: cage-shaped, pocket-shaped, pot-shaped, trough-shaped; and that the contact section is arranged within the mounting structure and merges, essentially along the mounting direction, into a recess for guiding the sensor element, in particular a sensor head of the sensor element, through toward the at least one cell unit.

By virtue of the respective configuration of the mounting structure, a comparatively compact structural design can be realized, for example. On the other hand, by such a configuration of the mounting structure, the sensor element can, for example, be protected.

It is possible that the contact section is formed as a tongue, a rib, a ramp, a clip, a web, or as a lever and is configured, in the assembly state, to arrange the sensor element with the at least one cell unit with the formation of an essentially play-free contact connection.

This ensures a comparatively simple assembly and arrangement of the sensor element, wherein in particular no additional or further elements or components are required.

According to a further aspect of the present invention, it can be provided that the mounting structure is formed to retain the at least one cell unit essentially in the mounting direction in order to arrange the at least one cell unit in a defined position and/or orientation relative to the mounting structure.

The defined location of the sensor element can comprise a location in which the sensor element, in particular a sensor head of the sensor element, contacts a shell surface (outer surface) of the at least one cell unit or forms a defined distance to a shell surface (outer surface) of the at least one cell unit.

According to a further aspect of the present invention, it can be provided that the mounting structure together with the retaining frame is formed integrally in one piece as an individual part, in particular by at least one of the following processes: a casting process, an injection process, a sintering process, a 3D printing process; a curing process, a shrinkage process; and/or that, in the assembly state, the mounting structure is filled with an essentially dimensionally stable filling material which is characterized by a defined yield point range.

The energy supply device can be characterized by a reduced number of parts due to an integrally one-piece configuration of the mounting structure together with the retaining frame as an individual part. The filler material can be a thermally conductive paste.

The present invention relates, according to a second general aspect, to a method for mounting a sensor element for detecting at least one operating state of at least one cell unit of a mobile energy supply device with a retaining frame for arranging the at least one cell unit in a mounting direction, wherein the retaining frame comprises at least one mounting structure with a contact section for the sensor element, with the method steps: • moving the sensor element essentially in the mounting direction, in particular linear (translational) moving of the sensor element; • sectionally changing of a shape of the sensor element by the contact section as a result of moving the sensor element, and/or • positioning and/or orientating the at least sectionally shape-changed sensor element by means of the contact section as a result of moving the sensor element until essentially a defined location is reached in order to be able to detect the at least one operating state at the at least one cell unit (directly and/or immediately).

The method according to the present invention can be a method for manufacturing a mobile energy supply device.

To avoid repetition, features directed purely at the device of the energy supply device according to the invention and/or disclosed in connection therewith shall also be deemed to be disclosed as part of the method and claimable, and vice versa.

### BRIEF DESCRIPTION OF THE DRAWINGS

The embodiments and features of the present invention described above can be combined with each other in any manner or as appropriate. Further or other details and advantageous effects of the present invention are explained in more detail below with reference to the accompanying figures.

It shows:

FIG. 1 a first embodiment of the mobile energy supply device according to the present invention in a perspective view, wherein a sensor element and a cell unit of the energy supply device are highlighted;

FIG. 2 the sensor element of the mobile energy supply device from FIG. 1 in a front view (main view);

FIG. 3 an enlarged section of the mobile energy supply device from FIG. 1 in a sectional view, wherein the sensor element is illustrated in a first state;

FIG. 4 an enlarged section of the mobile energy supply device from FIG. 1 in a sectional view, wherein the sensor element is illustrated in a first and a second state;

FIG. 5 an enlarged section of the mobile energy supply device from FIG. 1 in a top view of the mounting structure of the energy supply device;

FIG. 6 an arrangement with a plurality of cell units of the energy supply device from FIG. 1, which are arranged on a retaining frame.

Identical or functionally equivalent components or elements are indicated with the same reference signs in the figures. For their explanation, reference is also made in part to the description of other embodiments and/or figures in order to avoid repetition.

### DETAILED DESCRIPTION

The following detailed description of the embodiments shown in the figures serves for further illustration or clarification and is not intended to limit the scope of the present invention in any way.

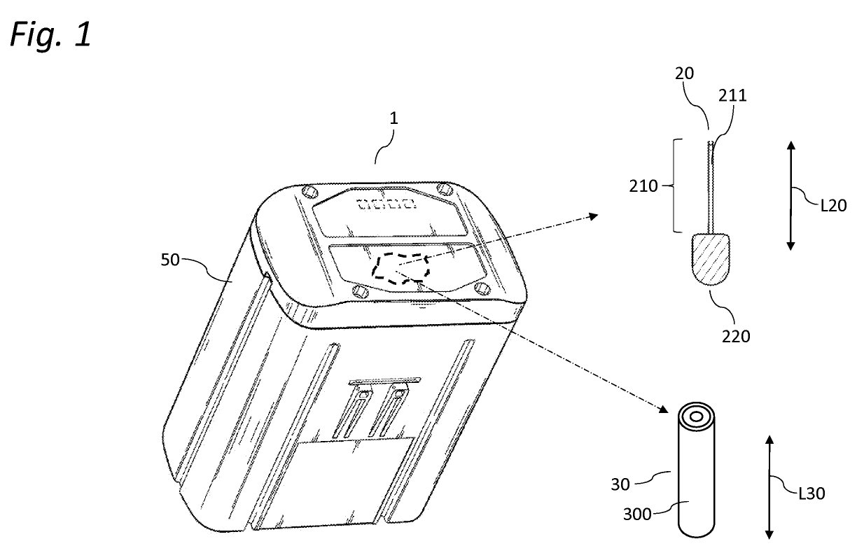

FIG. 1 shows a first embodiment of the mobile energy supply device 1 according to the present invention in a perspective view. A sensor element 20 and a cell unit 30 (also referred to as "cell" for short) of the energy supply device 1 are highlighted.

The mobile energy supply device 1 is a hand-held, hand-guided, manually tool-free mountable/dismountable, exchangeable, and/or rechargeable mobile energy supply device 1. For simplicity, the term "mobile" is omitted in connection with the energy supply device 1 in the following.

The energy supply device 1 can comprise a single cell unit 30 or a plurality of cell units 30. In the following, the energy supply device 1 is described in connection with a (single) cell unit 30.

The energy supply device 1 can be formed as a rechargeable battery pack in which the cell unit 30 is based on and/or formed using lithium-ion storage technology. Other electrochemical storage technologies are possible. The energy supply device 1 can be configured to establish a plug connection with a charging device and with an electrical appliance. The energy supply device 1 can be configured to supply electrical power to an electrical appliance in the configuration of a hand-held electric tool.

The energy supply device comprises the housing 50 for accommodating the cell unit 30 and other units and/or elements. The housing 50 can be formed from an insulating material based on a plastic. The housing 50 comprises housing sections in the configuration of walls and/or wall sections.

For detecting at least one operating state of the energy supply device 1, the energy supply device 1 comprises the sensor element 20. The at least one operating state can in particular comprise a temperature and/or a change in the temperature of the cell unit 30. In addition or alternatively, the at least one operating state can comprise, for example, a voltage of the cell unit 30. In the following, the energy supply device 1 is described with reference to the sensor element 20, which is configured for detection of a temperature of the cell unit 30.

The cell unit 30 is formed as a so-called round cell and is characterized by a cylindrical shape. The cell unit 30 comprises the shell surface (outer surface) 300. The cell unit 30 extends essentially along the longitudinal direction L30. The sensor element 20 extends essentially in a longitudinal direction L20 and comprises a sensor head 220 and two sensor holders 211 and 212, of which the sensor holder 211 is visible and indicated in FIG. 1. The section of the sensor holders 211, 212 forms a fastening section 210 of the sensor element 20, which is described in more detail below.

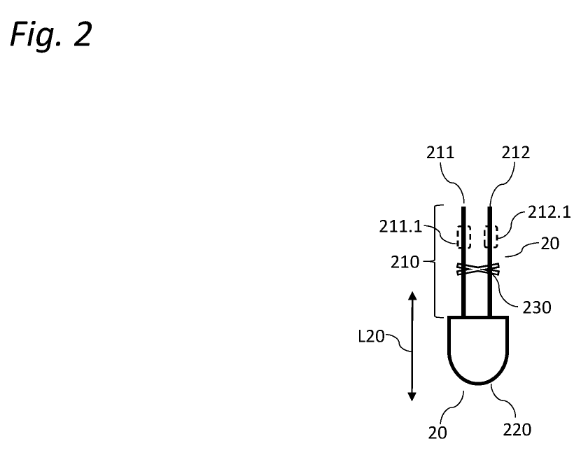

FIG. 2 shows the sensor element 20 of the energy supply device 1 from FIG. 1 in a front view (main view). The sensor element 20 is formed in particular as a so-called NTC sensor ("NTC" is an abbreviation for "Negative Temperature Coefficient") in order to detect a temperature by measuring a change of a resistance. The sensor element 20 comprises a sensor head 220. A sensor chip can be integrated in the sensor head 220. The sensor head 220 is formed, in particular, essentially dimensionally stable and essentially stiff, and particularly preferably essentially rigid.

Starting from the sensor head 220, the sensor holders 211 and 212 extend essentially along the longitudinal direction L20 of the sensor element 20. The longitudinal direction L20 can be a direction in and/or along which the sensor element 20 extends to its maximum and thus longest extent.

The sensor head 200 is configured to detect a temperature and/or a change in temperature. Each of the sensor holders 211 and 212 is formed cylindrical, in particular pencil-shaped. Each of the sensor holders 211 and 212 can, for example, be formed as a so-called wire pin. Each of the sensor holders 211 and 212 serves, on the one hand, for the mechanical fastening of the sensor element 20 and, on the other hand, for forming an electrical connection for operating the sensor element 20.

The sensor holders 211 and 212 are each formed of an electrically conductive material based on a metallic material and/or a metallic material alloy. The metallic material or the metallic material alloy is deformable, in particular essentially reversibly deformable and/or irreversibly deformable in sections. In an initial state (state prior to the assembly state) of the sensor element 20 and in an assembly state, the sensor element 20 is essentially dimensionally stable and remains in the defined location.

In order to maintain the distance between the sensor holders 211 and 212, in particular essentially along the longitudinal direction L20, a spacer element 230 can be arranged between the sensor holder 211 and the sensor holder 212. The spacer element 230 is arranged under the formation of a preload between the sensor holders 211 and 212.

The sensor holders 211 and 212 are each characterized by a deformation zone 211.1 and 212.1, at which a change in the shape of the sensor element 20 takes place during a mounting process and in the assembly state, as will be described in more detail in the following. The sensor holders 211 and 212 are part of the fastening section 210 of the sensor element 20, which merges into the sensor head 220.

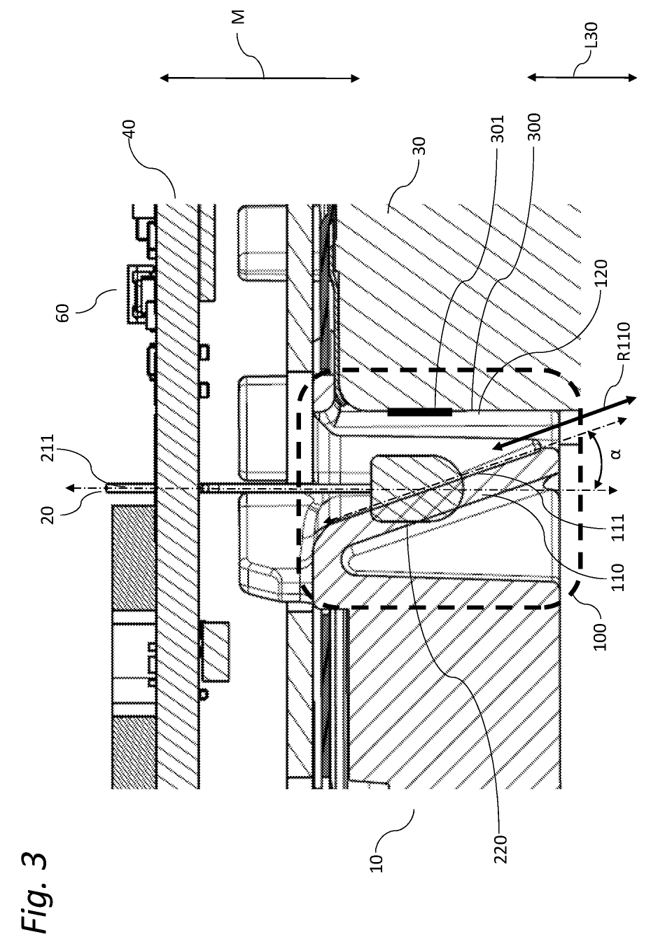

FIG. 3 shows a schematic illustration of an enlarged section of the mobile energy supply device 1 from FIG. 1 in a sectional view. The sensor element 20 is in a first state. The first state represents a state in which the sensor element 20 is not yet arranged in a defined location relative to the cell unit 30.

The sensor element 20 is fastened to a carrier material structure 40 of the energy supply device 1 via the sensor holders 211 and 212, of which the sensor holder 211 is visible and indicated in FIG. 3. The fastening of the sensor element 20 at the carrier structure 40 can be realized inter alia, in particular, by an essentially material-fitting connection, for example in the configuration of a solder connection. Due to the extension of the sensor holders 211 and 212, the sensor head 220 is arranged spaced apart from the carrier material structure 40. The sensor head 220 is arranged at a defined distance from the carrier material structure 40.

As already described, the sensor holders 211, 212 are pencil-shaped and can be deformed when made from a suitable material, in particular a metallic material. For this purpose, the sensor holders 211 and 212 comprise the deformation zones 211.1 and 212.1 (see also FIG. 2), which are configured to change at least in sections the shape of the sensor element 20 as a result of an assembly state.

The carrier material structure 40 is formed as a circuit board (PCB). In the embodiment shown, the carrier material structure 40 is formed plate-shaped. The carrier material structure 40 serves to support electrical/electronic parts and components. The electrical/electronic parts and components can, for example, be part of a so-called battery management system of the energy supply device 1. The battery management system is configured to control and/or regulate and/or monitor a charging process of the energy supply device 1. Among other things, the carrier material structure 40 serves for the arrangement and/or fastening of an electronic processing unit 60. The electronic processing unit 60 is connected to the sensor element 20. The electronic processing unit 60 is, for example, configured to detect changes in the resistance of the sensor head 220 of the sensor element 20 in order to determine, in particular to calculate, a temperature and/or a change in temperature.

The energy supply device 1 comprises the retaining frame 10 for arranging the cell unit 30. The retaining frame 10 forms a supporting structure with respect to the cell unit 30. The retaining frame 10 can represent a housing section and thus a wall and/or a wall section of the housing 50 of the energy supply device 1 (see also FIG. 1). The retaining frame 10 can, for example, be formed of an essentially dimensionally stable plastic as an insulating material. The retaining frame 10 can, for example, be formed as a separate individual part. The retaining frame 10 comprises at least one receiving section by means of which the cell unit 30 is arranged in a defined location and thus in a defined position and/or orientation in and/or along a mounting direction M on the retaining frame 10.

The retaining frame 10 comprises the mounting structure 100, which is configured for receiving and/or arranging the sensor element 20. The mounting structure 100 is essentially cage-shaped or pot-shaped and can, in particular, be an integral part of the retaining frame 10.

The mounting structure 100 comprises the contact section 110, which represents a wall or at least a wall section. The contact section 110 is arranged and/or formed within the mounting structure 100. The contact section 110 is arranged opposite and/or spaced apart from the cell unit 30. The contact section 110 comprises, as a wall section, the contact surface 111. The contact surface 111 is formed essentially planar (flat). The contact surface 111 is arranged and/or orientated at an angle or inclination to the mounting direction M, forming the angle of attack α. The angle of attack α of the contact surface 111 can, for example, be in a range between approximately 20° and approximately 50°. Alternatively, the contact surface 111 can be formed, along the assembly direction M, tapered, wedge-shaped, trapezoidal, concavely curved, groove-shaped, or trough-shaped.

The contact surface 111 serves, on the one hand, to guide the sensor head 220 of the sensor element 20. On the other hand, the contact surface 111 is configured, in an assembly state, to adjustably change the shape of the sensor element 20 at least in sections. The shape relates in particular to the geometric design of the sensor element 20. As already described, the sensor element 20 is a sensor element 20 deformable in sections, in particular in the area of the fastening section, i.e., the sensor holders 211 and 212, whereas the sensor head 220 is formed comparatively relatively stiff or, in particular, essentially rigid.

The adjustable sectionally change of the shape of the sensor element 20 is performed during or in the course of a mounting process of the carrier material structure 40 to the retaining frame 10 essentially in the mounting direction M, which is described in more detail in the following. During the mounting process, the carrier material structure 40 is moved with an essentially linear (translational) movement along the mounting direction M toward the retaining frame 10 and thus toward the mounting structure 100 with the contact surface 111.

After a certain distance, the contact surface 111 comes into contact with the sensor head 220. The sensor head 220 slides more or less along the contact surface 111 during a further movement of the carrier material structure 40 essentially along the mounting direction M. Simultaneously with the movement essentially in the mounting direction M, an orientating, i.e., a guidance of the sensor head 220, is performed by means of the configuration and/or arrangement of the contact surface 111 toward the cell unit 30. In other words, the sensor head 220 is gradually guided along a sliding direction R110 of the contact section 110 by the linear (translational) movement of the carrier structure 40 in the assembly direction M and is, in particular, simultaneously deflected toward the cell unit 30, especially pressed. A deformation of the sensor holders 211, 212 takes place at the deformation zones 211.1 and 212.1. The shape of the sensor element 20 can therefore be adjusted in sections. The sensor holders 211, 212 are subjected to a bending process during the mounting process.

The carrier material structure 40 and the arrangement of the sensor element 20 on the carrier material structure 40 are configured in relation to each other in such a way that, when the carrier material structure 40 moves essentially in the mounting direction M, in particular the sensor head 220 is moved toward a defined location.

The defined location can comprise a location of the sensor head 220 at which the sensor head 220 contacts a measuring point 301 on the shell surface 300 of the cell unit 30, in particular contacts it in an essentially play-free manner.

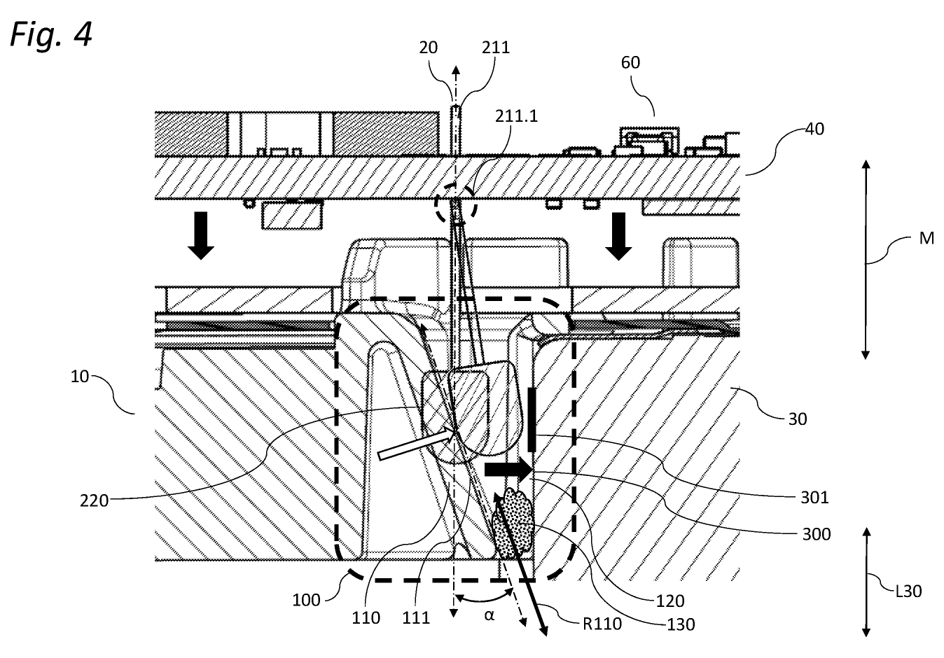

FIG. 4 shows a schematic representation of the enlarged section in FIG. 3 for further illustration, wherein the sensor element 20 is shown in a second state in addition to the first state.

The second state represents a state in which the sensor element 20 is changed in shape at least in sections a result of the movement of the carrier material structure 40 in the course of the mounting process. The change of the shape of the sensor element 20 in sections is realized by the deformation zones on the sensor holders 211 and 212, of which the deformation zone 211.1 on the sensor holder 211 is visible and indicated in FIG. 4. Within the deformation zones 211.1 and 212.1, for example, an essentially reversible deformation at least in sections can take place, which is accompanied by the generation of a preload force in the sensor element 20. In other words, the change of shape of the sensor element 20 at least in sections allows, in particular, the sensor head 220 to be pressed at the contact surface 111, wherein a contact connection between the sensor head 220 and the contact surface 111 is always maintained. The contact surface 111 serves, inter alia, to support the sensor head 220, as indicated by a white arrow in FIG. 4.

With advancing movement of the carrier material structure 40 essentially in the mounting direction M, which is additionally symbolized in part by black arrows in FIG. 4, the sensor element 20, and in particular the sensor head 220, reaches the defined location, after which the sensor head 220 is arranged at least opposite the measuring point 301 on the shell surface 300. In particular, as already described, the defined location comprises a location of the sensor element 20 in which the sensor head 220 contacts the measuring point 301 and thus the cell unit 30, in particular in an essentially play-free manner. It is additionally possible that the sensor head 220 contacts the measuring point 301 with a comparatively low pressing force. Alternatively, it is possible that the defined location comprises a location in which the sensor head 220 is arranged opposite the measuring point 301 at a defined distance.

For guiding the sensor element 20, in particular the sensor head 220, toward the cell unit 30, the contact section 110 merges within the mounting structure 100 along the mounting direction M into the recess 120 and passes through the recess 120 in the direction of the cell unit 30. It is understood that, in the assembly state of the sensor element 20, the carrier material structure 40 is fastened to the retaining frame 10 in a defined assembly location.

The sensor element 20 is received within the mounting structure 100 and arranged on the cell unit 30. In addition, the receiving space of the mounting structure 100 can be filled with a filling material 130. The filling material 130 can be, for example, a thermally conductive paste.

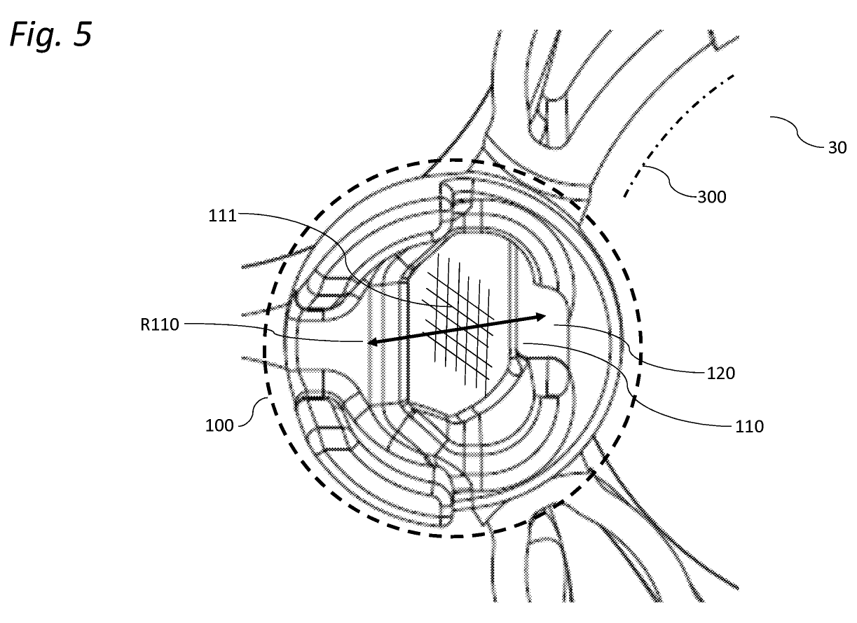

FIG. 5 shows in a schematic illustration an enlarged section of the mobile energy supply device 1 from FIG. 1 in a top view to the mounting structure 100. The sensor element 20 is hidden in this illustration.

The integration of the mounting structure 100 with the contact section 110 into the retaining frame 10 is clearly apparent. The pot-shaped configuration of the mounting structure 100 enables a protected arrangement of the sensor element 20 within the energy supply device 1 and thus, for example, between respectively adjacent cell units 30.

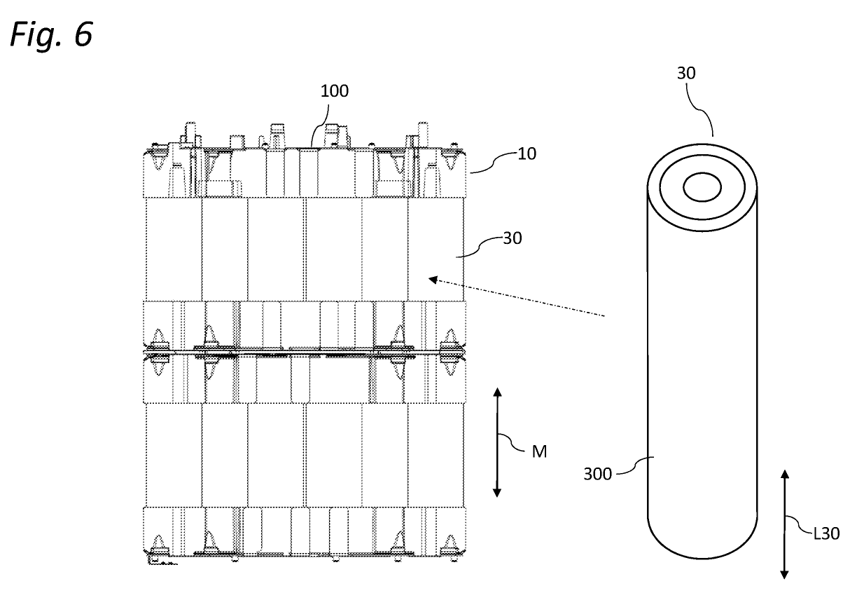

FIG. 6 additionally shows an arrangement with a plurality of cell units 30 of the energy supply device 1, which are arranged on a retaining frame 10.

The mounting structure 100 for receiving and arranging the sensor element 20 is integrated into the retaining frame 10 in a comparatively space-saving manner and ensures the arrangement of the sensor element 20 in a defined location. An operating state, in particular a temperature and/or a change in temperature, of the cell unit 30 can be detected more precisely by means of the present invention.

The present invention is not limited to the embodiments described above. Rather, a variety of variants and modifications are possible which also make use of the inventive concept and therefore fall within the scope of protection. Preferably, the present invention also claims protection for the subject matter and features of the dependent claims independently of the claims referred to.

### LIST OF REFERENCE SIGNS

1 energy supply device

10 retaining frame

20 sensor element

30 cell unit

40 carrier material structure

50 housing

60 processing unit

100 mounting structure

110 contact section

111 contact area

120 recess

130 filling material

210 fastening section

211 sensor holder

211.1 deformation zone

212 sensor holder

212.1 deformation zone

220 sensor head

230 spacer element

300 shell surface

301 measuring point

L20 longitudinal direction

L30 longitudinal direction

M Mounting direction

R110 sliding direction

α angle of attack

What is claimed is:

1. A mobile energy supply device with a retaining frame for arranging at least one cell unit in a mounting direction,
wherein the retaining frame comprises at least one mounting structure for a sensor element for detecting at least one operating state of the at least one cell unit,
wherein the at least one mounting structure comprises a contact section which is configured, in an assembly state, to adjustably change a shape of the sensor element at least in sections and to arrange the at least sectionally shape-changed sensor element in a defined location relative to the at least one cell unit in order to be able to detect the at least one operating state at the at least one cell unit.

2. The energy supply device according to claim 1,
wherein, in the assembly state, the sensor element is mechanically fastened and/or electrically contacted
by means of a carrier material structure for at least one unit of the energy supply device, or
by means of a housing section of a housing of the energy supply device,
wherein the carrier material structure or the housing section is in each case connected to the retaining frame by a mounting process in the mounting direction,
wherein, in the assembly state, the sensor element is received in the mounting structure, wherein the mounting structure is arranged opposite the carrier material structure or the housing section in the mounting direction.

3. The energy supply device according to claim 1,
wherein the sensor element comprises two sensor holders which extend from a sensor head of the sensor element in a longitudinal direction of the sensor element and are arranged opposite each other and/or spaced apart from each other,
wherein, for maintaining a distance between the two sensor holders, a spacer element is arranged between the two sensor holders, which is mounted so as to be displaceable in the longitudinal direction in order to set a defined variability of a shape of the sensor element.

4. The energy supply device according to claim 1,
wherein the contact section is arranged opposite and/or spaced apart from the at least one cell unit and is configured to deform and/or to displace the sensor element at least in sections in the direction of the at least one cell unit as a result of an assembly movement along the mounting direction.

5. The energy supply device according to claim 1,
wherein the contact section comprises a contact surface which is associated with the sensor element and configured to support the sensor element in the assembly state in at least one direction.

6. The energy supply device according to claim 1,
wherein the contact section comprises a contact surface which is associated with the sensor element, wherein the contact surface is characterized by at least one of the following configurations: planar, tapering along the mounting direction, wedge-shaped, trapezoidal, concavely curved, channel-shaped, trough-shaped;
in order in each case to position and/or orientate the sensor element in the defined location in the assembly state.

7. The energy supply device according to claim 1,
wherein the mounting structure is characterized by one of the following configurations: cage-shaped, pocket-shaped, pot-shaped, trough-shaped; and
wherein the contact section is arranged within the mounting structure and merges, along the mounting direction, into a recess for guiding the sensor element through toward the at least one cell unit.

8. The energy supply device according to claim 1,
wherein the contact section is formed as a tongue, a rib, a ramp, a clip, a web, or a lever and is configured, in the assembly state, to arrange the sensor element with the at least one cell unit with the formation of an essentially play-free contact connection.

9. The energy supply device according to claim 1,
wherein the mounting structure together with the retaining frame is formed integrally in one piece as an individual part; and/or
wherein, in the assembly state, the mounting structure is filled with a dimensionally stable filling material which is characterized by a defined yield point range.

10. A method for mounting a sensor element for detecting at least one operating state of at least one cell unit of a mobile energy supply device with a retaining frame for arranging the at least one cell unit in a mounting direction,
wherein the retaining frame comprises at least one mounting structure with a contact section for the sensor element,
with the method steps:
moving the sensor element in the mounting direction;
sectionally changing a shape of the sensor element by the contact section as a result of moving the sensor element, and/or
positioning and/or orientating the at least sectionally shape-changed sensor element by means of the contact section as a result of moving the sensor element,
until a defined location is reached in order to be able to detect the at least one operating state at the at least one cell unit.
